(19) United States
(12) Patent Application Publication
(10) Pub. No.: US 2026/0168313 A1
(43) Pub. Date: Jun. 18, 2026

(54) Removable Window Panel Device

(71) Applicant: Richard Conybear, Littleton, CO (US)

(72) Inventor: Richard Conybear, Littleton, CO (US)

(21) Appl. No.: 18/979,162

(22) Filed: Dec. 12, 2024

(51) Int. Cl. E06B 3/28; E06B 9/52

(52) U.S. Cl. CPC E06B 3/28; E06B 9/52

(57) ABSTRACT

A screen window replacement device includes a window that has a screen window opening and a screen window which is removably insertable into the screen window opening. A frame is provided and the frame is removably insertable into the screen window opening to replace the screen window with the frame. A window pane is integrated into the frame to inhibit wind from blowing through the screen window opening when the frame is inserted into the screen window opening. A pair of springs is each movably attached to the frame to retain the frame in the screen window opening and a pair of pull tabs is each coupled to the frame. The pair of pull tabs can be pulled upon by the user to remove the frame from the screen window opening.

### (b) CROSS-REFERENCE TO RELATED APPLICATIONS

I hereby claim the benefit under 35 U.S.C. Section 119(e) of U.S. Provisional application ______ (serial number) (date of filing)

I hereby claim the benefit under 35 U.S.C., Section 120 of U.S. application ______ (serial number) (date of filing)

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to screen window devices and more particularly pertains to a new screen window device for replacing a screen window with a window pane. The device includes a frame which is insertable into a screen window opening in a window to replace a screen window in the screen window opening. The device includes a window pane integrated into the frame to inhibit wind from blowing through the screen window opening and a pair of springs each movably attached to the frame which secure the frame in the screen window opening and a pair of pull tabs each attached to the frame which can be gripped by a user to remove the frame from the screen window opening.

### (2) Description of Related Art Including Information Disclosed Under 37 CFR 1.97 and 1.98

The prior art relates to screen window devices including: a variety of thermal inserts for window frames that includes a thermally insulating blanket that is positioned in a window frame; a variety of modular windowpane inserts for attaching an additional windowpane to a window frame. In no instance does the prior art disclose a screen window replacement device that includes a frame that is structured to match the height and width of a screen window opening in a window and a window pane integrated into the frame which replaces a screen window in the screen window opening.

### (h) BRIEF SUMMARY OF THE INVENTION

An embodiment of the disclosure meets the needs presented above by generally comprising a window that has a screen window opening and a screen window which is removably insertable into the screen window opening. A frame is provided and the frame is removably insertable into the screen window opening to replace the screen window with the frame. A window pane is integrated into the frame to inhibit wind from blowing through the screen window opening when the frame is inserted into the screen window opening. A pair of springs is each movably attached to the frame to retain the frame in the screen window opening and a pair of pull tabs is each coupled to the frame. The pair of pull tabs can be pulled upon by the user to remove the frame from the screen window opening.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a screen window replacement device according to an embodiment of the disclosure.

FIG. 2 is a back perspective view of an embodiment of the disclosure.

FIG. 3 is a front view of an embodiment of the disclosure.

FIG. 4 is a magnified detail view taken from oval 4 of FIG. 3 of an embodiment of the disclosure.

FIG. 5 is a right side view of an embodiment of the disclosure.

FIG. 6 is a top view of an embodiment of the disclosure.

FIG. 7 is a front view of an alternative embodiment of the disclosure.

FIG. 8 is a cross sectional view taken along line 8-8 of FIG. 7 of an alternative embodiment of the disclosure.

### (j) DETAILED DESCRIPTION OF THE INVENTION

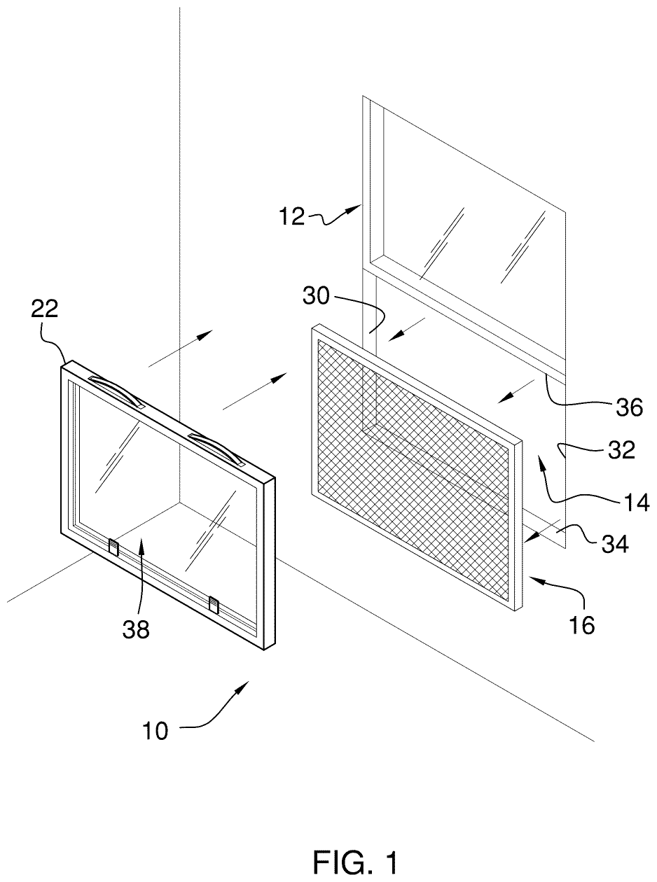

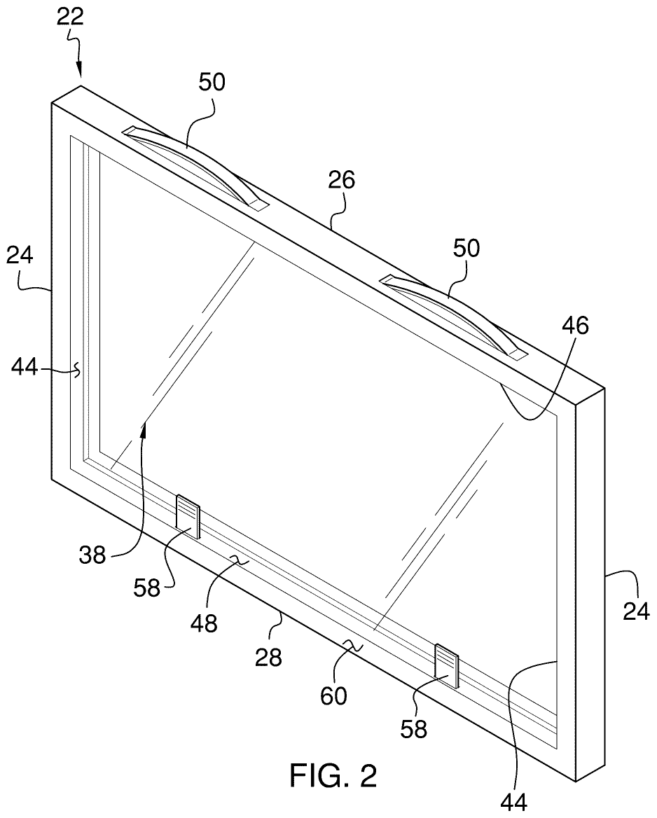

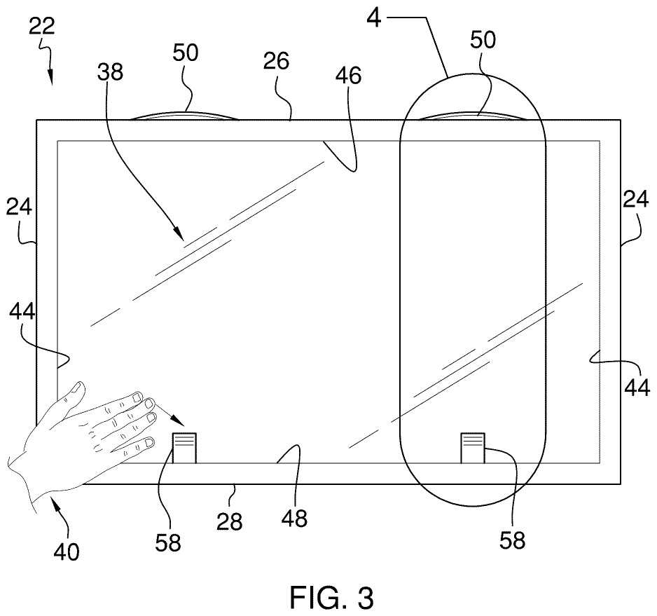

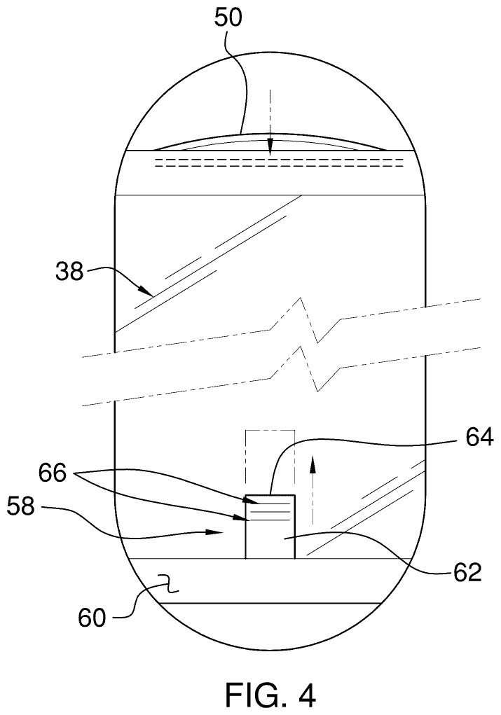

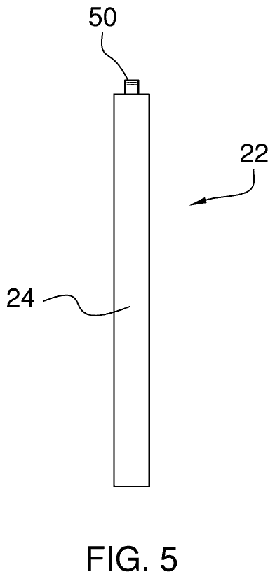

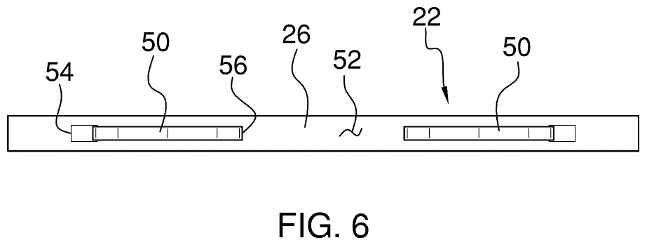

With reference now to the drawings, and in particular to FIGS. 1 through 8 thereof, a new screen window device embodying the principles and concepts of an embodiment of the disclosure and generally designated by the reference numeral 10 will be described.

As best illustrated in FIGS. 1 through 8, the screen window replacement device 10 generally comprises a window 12 that has a screen window opening 14 and a screen window 16 which is removably insertable into the screen window opening 14. The window 12 may be a single hung window of any conventional design, for example, which is installed in an exterior wall 18 of a building 20, such as a house, for example. Additionally, the screen window 16 may be a screen window of any conventional design that is installed in a window to inhibit bugs from passing through the window when the window is opened. A frame 22 is structured to have a height and a width which corresponds to a height and a width of the screen window opening 14 in the window 12. Furthermore, the screen window 16 is removable from the screen window opening 14 having the frame 22 being removably insertable into the screen window opening 14 to replace the screen window 16 with the frame 22.

The frame 22 has a pair of sidelong members 24 each extending between a top member 26 and a bottom member 28; the pair of sidelong members 24 is oriented parallel to each other and is oriented perpendicular to each of the top member 26 and the bottom member 28 such that the frame 22 has a rectangular shape. Each of the pair of sidelong members 24 abuts a respective one of a first lateral side 30 and a second lateral side 32 of the screen window opening 14. Furthermore, the bottom member 28 abuts a lower side 34 of the screen window opening 14 and the top member 26 abuts an upper side 36 of the screen window opening 14. The frame 22 may be manufactured in a variety of heights and widths to correspond to a variety of sizes and styles of windows, including but not being limited to single hung windows and double hung windows and picture windows.

A window pane 38 is integrated into the frame 22 such that the frame 22 surrounds the window pane 38. Furthermore, the window pane 38 is comprised of a fluid impermeable material, including but not being limited to polycarbonate or glass, to inhibit wind from blowing through the screen window opening 14 when the frame 22 is inserted into the screen window opening 14. Additionally, the fluid impermeable material comprises a translucent material to pass light through the window pane 38 such that a user 40 can see through the window pane 38 when the frame 22 is inserted into the screen window opening 14. The window pane 38 has a perimeter edge 42 and the perimeter edge is recessed into an inwardly facing surface 44 of each sidelong member 24 of the pair of sidelong members 24 and an inwardly facing surface 46 of the top member 26 and an inwardly facing surface 48 of the bottom member 28 such that the window pane 38 is secured to the frame 22.

A pair of springs 50 is provided and each spring 50 of the pair of springs 50 is movably attached to the frame 22. Each spring 50 of the pair of springs 50 is biased to curve away from the frame 22 and each spring 50 of the pair of springs 50 is compressible toward the frame 22. The pair of springs 50 compresses against a respective side of the screen window opening 14 when the frame 22 is positioned in the screen window opening 14. The pair of springs 50 inhibit the wind from blowing the window pane 38 and the frame 22 out of the screen window opening 14. Conversely, the frame 22 is removable from the screen window opening 14 when the pair of springs 50 is urged to travel toward the frame 22 such that the pair of springs 50 do not impede the frame 22 being removed from the screen window opening 14.

Each spring 50 of the pair of springs 50 is disposed on an outwardly facing surface 52 of the top member 26 of the frame 22 and each spring 50 of the pair of springs 50 is oriented to extend along a line which extends between the pair of sidelong members 24 of the frame 22. Additionally, each spring 50 of the pair of springs 50 is spaced from a respective one of the pair of sidelong members 24 of the frame 22 and each spring 50 of the pair of springs 50 is biased to curve upwardly from the outwardly facing surface 52 of the top member 26. Each spring 50 of the pair of springs 50 has a first end 54 and a second end 56 which are each slidably attached to the outwardly facing surface 52 of the top member 26. Furthermore, the first end 54 and the second end 56 of a respective spring 50 travels away from each other when the respective spring is compressed toward the outwardly facing surface 52 of the top member 26.

A pair of pull tabs 58 is each coupled to the frame 22 such that each pull tab 58 of the pair of pull tabs 58 can be pulled upon by the user 40. Each spring 50 of the pair of springs 50 is compressed toward the frame 22 when the pair of pull tabs 58 is pulled upwardly. Furthermore, the pair of pull tabs 58 can be pulled upwardly by the user 40 to remove the frame 22 from the screen window opening 14. Each pull tab 58 of the pair of pull tabs 58 is disposed on the inwardly facing surface 48 of the bottom member 28 of the frame 22. Additionally, each pull tab 58 of the pair of pull tabs 58 is positioned between the window pane 38 and a rearwardly facing surface 60 of the bottom member 28. Each pull tab 58 of the pair of pull tabs 58 is aligned with a respective spring 50 of the pair of springs 50.

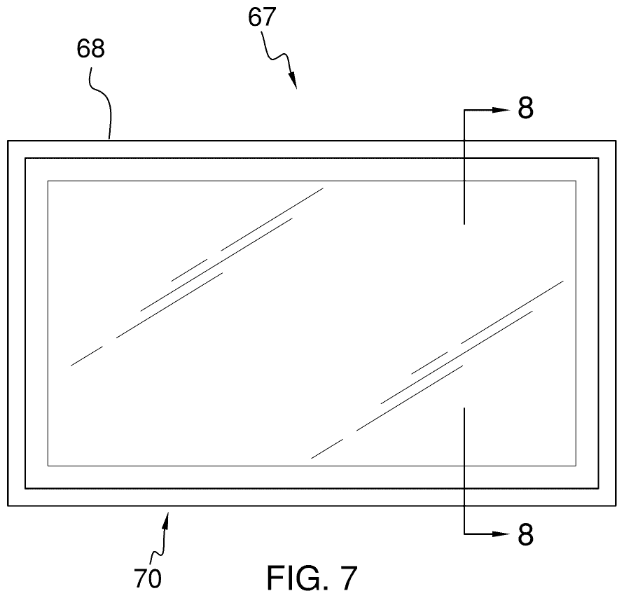

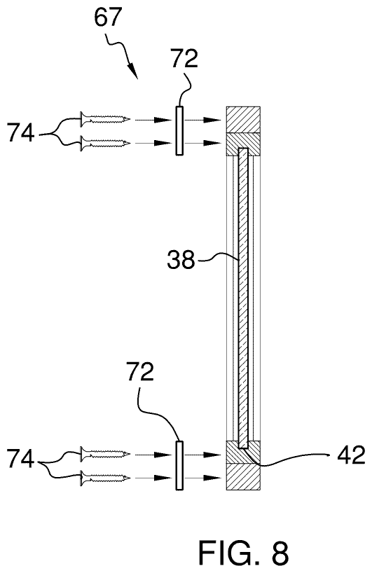

Each pull tab 58 of the pair of pull tabs 58 has a back side 62 that is directed toward the rearwardly facing surface 60 of the bottom member 28 and each pull tab 58 of the pair of pull tabs 58 has a top end 64. Furthermore, each pull tab 58 of the pair of pull tabs 58 has a series of ridges 66 on the back side 62 of a respective tab 58 which are spaced apart from each other and are distributed from the top end 64 of the respective tab and the frame 22. The series of ridges 66 on the back side 62 of each pull tab 58 of the pair of pull tabs 58 enhances a grip of the user 40 on each pull tab 58 when the user 40 grips the pair of pull tabs 58. In an alternative embodiment 67 as is shown in FIGS. 7 and 8, the frame 22 can be permanently mounted in a window frame 68 of a picture window 70, for example, using brackets 72 that are attached between the frame 22 and the window frame 68 of the picture window 70. Penetrating fasteners 74, such as screws for example, can be employed to secure the brackets 72 to the frame 22 and the window frame 68 of the picture window 70.

In use, the screen window 16 is removed from the screen window opening 14 and the top member 26 of the frame 22 is pressed against the upper side 36 of the screen window opening 14 such that the pair of springs 50 is compressed against the top member 26 of the frame 22. The frame 22 is tilted to position the bottom member 28 against the lower side 34 of the screen window opening 14 and the frame 22 is released such that the pair of springs 50 subsequently urges the bottom member 28 to press against the lower side 34 of the screen window opening 14. Furthermore, the window pane 38 in the frame 22 inhibits wind from blowing through the screen window opening 14 when the window 12 is opened as would occur when the screen window 16 is installed in the screen window opening 14. Each of the pair of pull tabs 58 is pulled upwardly to compress the springs 50 to subsequently remove the frame 22 from the screen window opening 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A screen window replacement device comprising:
a window having a screen window opening;
a screen window being removably insertable into said screen window opening;
a frame being structured to have a height and a width which corresponds to a height and a width of said screen window opening in said window, said screen window being removable from said screen window opening having frame being removably insertable into said screen window opening to replace said screen window with said frame;
a window pane being integrated into said frame such that said frame surrounds said window pane, said window pane being comprised of a fluid impermeable material wherein said window pane is configured to inhibit wind from blowing through said screen window opening when said frame is inserted into said screen window opening, said fluid impermeable material comprising a translucent material wherein said window pane is configured to pass light through said window pane such that a user can see through said window pane when said frame is inserted into said screen window opening;
a pair of springs, each spring of said pair of springs being movably attached to said frame, each spring of said pair of springs being biased to curve away from said frame, each spring of said pair of springs being compressible toward said frame, said pair of springs compressing against a respective side of said screen window opening when said frame is positioned in said screen window opening wherein said pair of springs is configured to inhibit the wind from blowing said window pane and said frame out of said screen window opening; and
a pair of pull tabs, each pull tab of said pair of pull tabs being coupled to said frame wherein each pull tab of said pair of pull tabs is configured to be pulled upon by the user, each spring of said pair of springs being compressed to travel toward said frame when said pair of pull tabs is pulled upwardly wherein said pair of tabs is configured to be pulled upwardly by the user to remove said frame from said screen window opening.

2. The screen window replacement device according to claim 1, wherein:
said frame has a pair of sidelong members each extending between a top member and a bottom member;
said pair of sidelong members is oriented parallel to each other and is oriented perpendicular to each of said top member and said bottom member such that said frame has a rectangular shape.

3. The screen window replacement device according to claim 2, wherein:
each of said pair of sidelong members abuts a respective one of a first lateral side and a second lateral side of said screen window opening; and
said bottom member abuts a lower side of said screen window opening; and
said top member abuts an upper side of said screen window opening.

4. The screen window replacement device according to claim 2, wherein:
said window pane has a perimeter edge; and
said perimeter edge is recessed into an inwardly facing surface of each sidelong member of said pair of sidelong members and an inwardly facing surface of said top member and an inwardly facing surface of said bottom member such that said window pane is secured to said frame.

5. The screen window replacement device according to claim 2, wherein:
each spring of said pair of springs is disposed on an outwardly facing surface of said top member of said frame; and
each spring of said pair of springs is biased to curve upwardly from said outwardly facing surface of said top member.

6. The screen window replacement device according to claim 2, wherein each spring of said pair of springs is oriented to extend along a line which extends between said pair of sidelong members of said frame.

7. The screen window replacement device according to claim 2, wherein each spring of said pair of springs is spaced from a respective one of said pair of sidelong members of said frame.

8. The screen window replacement device according to claim 2, wherein:
each pull tab of said pair of pull tabs is disposed on an inwardly facing surface of said bottom member of said frame;
each pull tab of said pair of pull tabs is positioned between said window pane and a rearwardly facing surface of said bottom member; and
each pull tab of said pair of pull tabs is aligned with a respective spring of said pair of springs.

9. The screen window replacement device according to claim 2, wherein:
each pull tab of said pair of pull tabs has a back side being directed toward a rearwardly facing surface of said bottom member of said frame;
each pull tab of said pair of pull tabs has a top end; and
each pull tab of said pair of pull tabs has a series of ridges on said back side of a respective tab which are spaced apart from each other and are distributed from said top end of said respective tab and said frame wherein said series of ridges on said back side of each pull tab of said pair of pull tabs is configured to enhance a grip of the user on each pull tab when the user grips said pair of pull tabs.

10. A screen window replacement device comprising:
a window having a screen window opening;
a screen window being removably insertable into said screen window opening;
a frame being structured to have a height and a width which corresponds to a height and a width of said screen window opening in said window, said screen window being removable from said screen window opening having frame being removably insertable into said screen window opening to replace said screen window with said frame, said frame having a pair of sidelong members each extending between a top member and a bottom member, said pair of sidelong members being oriented parallel to each other and being oriented perpendicular to each of said top member and said bottom member such that said frame has a rectangular shape, each of said pair of sidelong members abutting a respective one of a first lateral side and a second lateral side of said screen window opening, said bottom member abutting a lower side of said screen window opening, said top member abutting an upper side of said screen window opening;
a window pane being integrated into said frame such that said frame surrounds said window pane, said window pane being comprised of a fluid impermeable material wherein said window pane is configured to inhibit wind from blowing through said screen window opening when said frame is inserted into said screen window opening, said fluid impermeable material comprising a translucent material wherein said window pane is configured to pass light through said window pane such that a user can see through said window pane when said frame is inserted into said screen window opening, said window pane having a perimeter edge, said perimeter edge being recessed into an inwardly facing surface of each sidelong member of said pair of sidelong members and an inwardly facing surface of said top member and an inwardly facing surface of said bottom member such that said window pane is secured to said frame;
a pair of springs, each spring of said pair of springs being movably attached to said frame, each spring of said pair of springs being biased to curve away from said frame, each spring of said pair of springs being compressible toward said frame, said pair of springs compressing against a respective side of said screen window opening when said pair springs is biased to curve away from said frame when said frame is positioned in said screen window opening wherein said pair of springs is configured to inhibit the wind from blowing said window pane and said frame out of said screen window opening, each spring of said pair of springs being disposed on an outwardly facing surface of said top member of said frame, each spring of said pair of springs being oriented to extend along a line which extends between said pair of sidelong members of said frame, each spring of said pair of springs being spaced from a respective one of said pair of sidelong members of said frame, each spring of said pair of springs being biased to curve upwardly from said outwardly facing surface of said top member; and
a pair of pull tabs, each pull tab of said pair of pull tabs being coupled to said frame wherein each pull tab of said pair of pull tabs is configured to be pulled upon by the user, each spring of said pair of springs being compressed toward said frame when said pair of pull tabs is pulled upwardly wherein said pair of tabs is configured to be pulled upwardly by the user to remove said frame from said screen window opening, each pull tab of said pair of pull tabs being disposed on said inwardly facing surface of said bottom member of said frame, each pull tab of said pair of pull tabs being positioned between said window pane and a rearwardly facing surface of said bottom member, each pull tab of said pair of pull tabs being aligned with a respective spring of said pair of springs, each pull tab of said pair of pull tabs having a back side being directed toward said rearwardly facing surface of said bottom member, each pull tab of said pair of pull tabs having a top end, each pull tab of said pair of pull tabs having a series of ridges on said back side of a respective tab which are spaced apart from each other and are distributed from said top end of said respective tab and said frame wherein said series of ridges on said back side of each pull tab of said pair of pull tabs is configured to enhance a grip of the user on each pull tab when the user grips said pair of pull tabs.
